(19) United States
(12) Patent Application Publication
(10) Pub. No.: US 2002/0131572 A1
(43) Pub. Date: Sep. 19, 2002

(54) Method and apparatus for scheduling appointments

(76) Inventor: Peter R. Paradis, San Jose, CA (US)

Correspondence Address: KENYON & KENYON, Suite 600, 333 W. San Carlos, Street, San Jose, CA, 95110-2711, US

(21) Appl. No.: 10/028,093

(22) Filed: Oct. 24, 2001

Related U.S. Application Data
(60) Provisional application No. 60/245,765, filed on Nov. 2, 2000.

(51) Int. Cl. H04M 1/66

(52) U.S. Cl. 379/200

(57) ABSTRACT

A method and system are presented where a server system is able to handle a majority of the processing work in determining and booking available schedule appointments between a patient's schedule and the schedules of the required resources (e.g., personnel, examination rooms, equipment, services, etc.). The server system includes local memory that stores a portion of patient and resource schedules from a database and handles task requests from a client system. Because the majority of the processing work is done at the server, the bandwidth of the connection between the client and server may be low (e.g., a 28.8 K modem), and the client does not necessarily need extensive memory and processing capabilities (e.g., a standard personal computer or PDA).

### BACKGROUND OF THE INVENTION

The present invention pertains to a method and apparatus for scheduling appointments. More particularly, the present invention pertains to a method and apparatus that organizes and works on scheduling information in an improved manner.

In known scheduling systems, a database is typically provided that stores an abundance of information. For example, in the medical field, such a database would store patient information (e.g., name, address, telephone number, prior medial treatment, etc.). An example of a system that is known in the art is shown in FIG. 1. In FIG. 1, a client 11 is provided (e.g., a network computer) coupled to a database 13 via a LAN (local area network). With such a closely tied relationship between the client 11 and database, a lot of data may be moved between the two devices. The programming for performing the search/organization/format for the information stored at database 13 typically resides and is executed in the client.

In another known scheduling system shown in FIG. 2, a server 23 is placed between the client 21 and database 25. In this environment, the programming code for performing the search/organization/format for the information stored at database 13 typically resides and is executed at the database 25. This leads to a very slow turnaround between requests made at the client 21 and the resulting output from the database. Furthermore, once a search of records is performed at the database 25, the results are often discarded after being output to the client 21. Thus, further searches of the database typically require a full search of the database records.

In view of the problems with the known systems described above, there is a need for an improved method and apparatus for the handling of scheduling information.

### SUMMARY OF THE INVENTION

This and other needs are satisfied by the method and apparatus of the present invention. In one embodiment of the method of the present invention for scheduling appointments, a task request is sent from a client to a server system that includes patient identification and resource identification. It is then determined at the server system whether schedules associated with the patient identification and resource identification are stored in local memory to the server system. The associated patient schedule and resource schedule are then loaded from a database into the local memory. With this information, the server can determine available times for the resource schedule.

In further embodiments of the method of the present invention, the server begins determining available times from a start timestamp provided in the task request for a period of time (the given date in the timestamp). If no available times are found for the resource schedule, then the server moves to the next period of time. When an available time is found, it can then be transmitted to the client. Using this method, a majority of the processing needed to find available appointments can be done by the server system on data stored in local memory. Also, the amount of data transmitted between the server and client can be kept to a minimum allowing the client to be a personal computer or PDA coupled to the Internet, for example.

### BRIEF DESCRIPTION OF THE DRAWINGS

FIG. 1 is a block diagram of a database system that is known in the art.

FIG. 2 is a block diagram of a database system that is known in the art.

FIG. 3 is a block diagram of a system constructed according to an embodiment of the present invention.

FIGS. 4a-b are flow diagrams of a method according to an embodiment of the present invention.

FIG. 5 is an example of an input screen for patient identification information.

FIG. 6 is an example of an input screen for providing a task request.

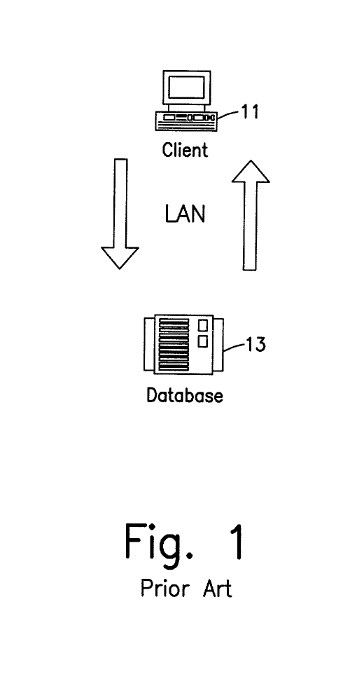

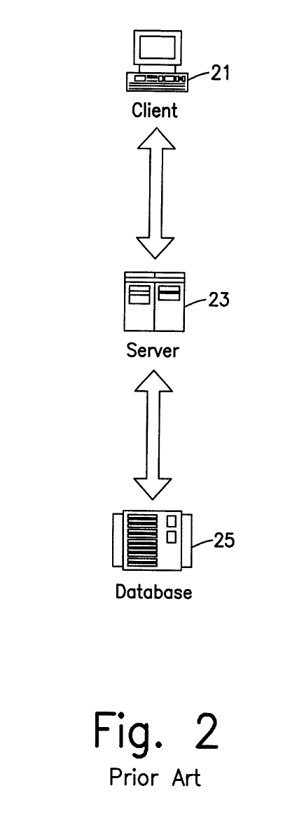

### DETAILED DESCRIPTION

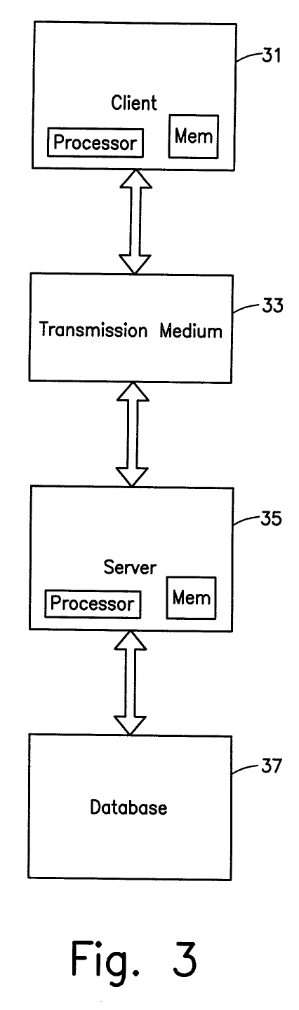

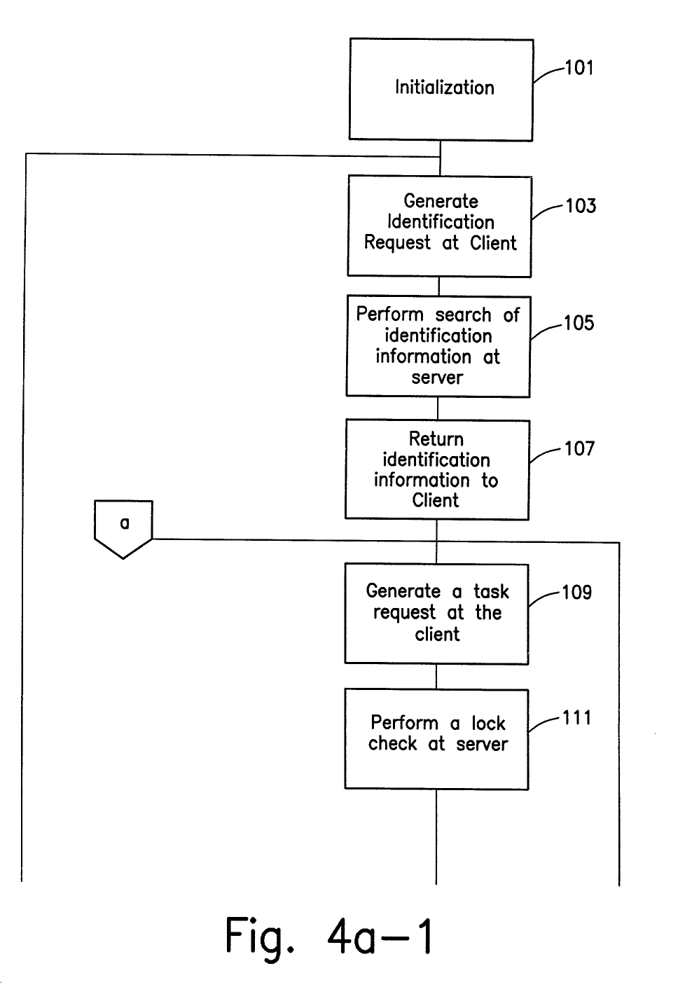

Referring to FIG. 3, a block diagram of a system constructed according to an embodiment of the present invention is shown. The system includes a client 31 coupled to a transmission medium. In this example, the client may be a personal computer with random access memory (RAM; e.g., 64 M of RAM) or a personal digital assistant (PDA) such as those manufactured by Palm Inc. The client is coupled to a transmission medium 33 in any of a variety of known ways. For example, the client 31 may be coupled to a network system such as the Internet via a modulator/demodulator (modem) at the client. In turn, a server 35 is coupled to the transmission medium and is capable of communication with the client. In this embodiment, the server 35 includes a processor and a substantial amount of cache memory. For example, the server 35 may include in excess of 1 gigabyte of Dynamic RAM (DRAM). The server 35 is also coupled to one or more storage devices such as database 37, which includes one or more hard-disk drives in this embodiment.

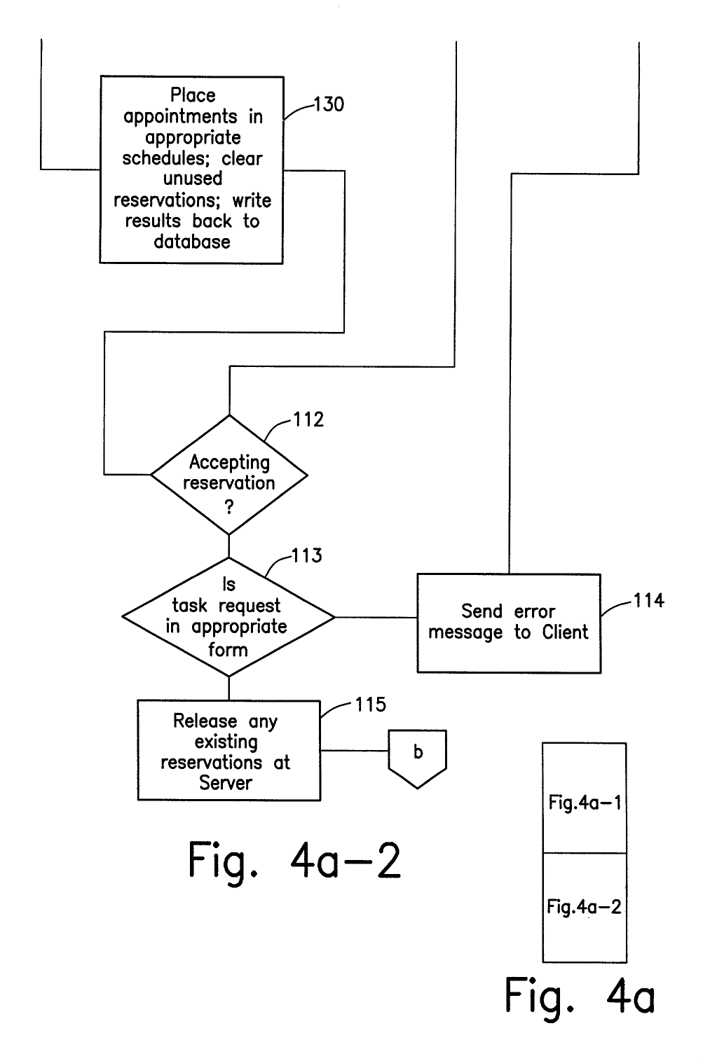

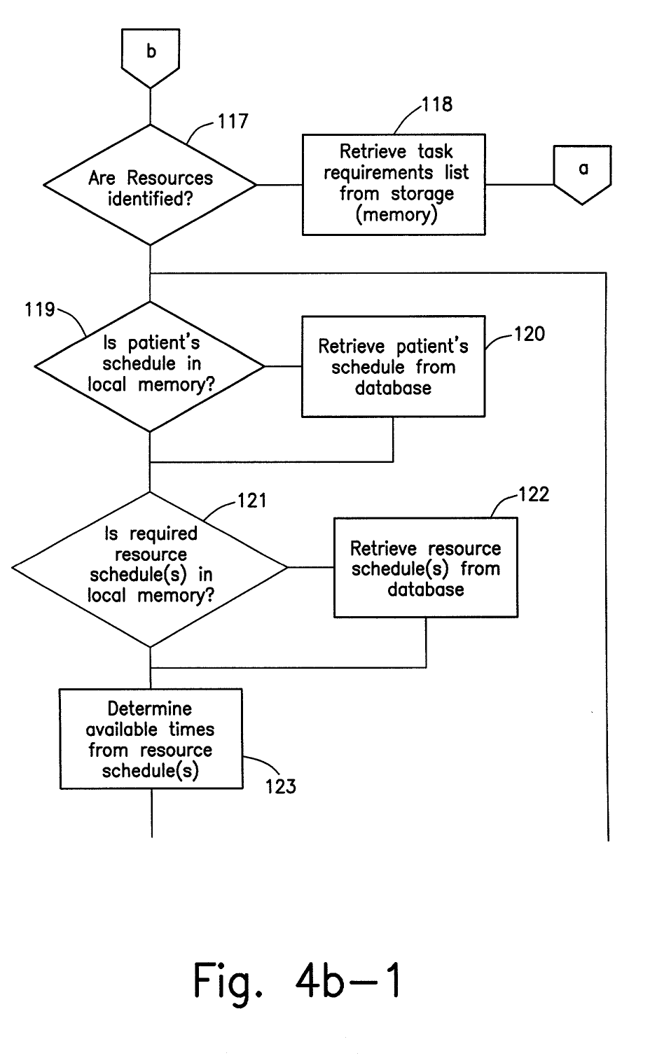

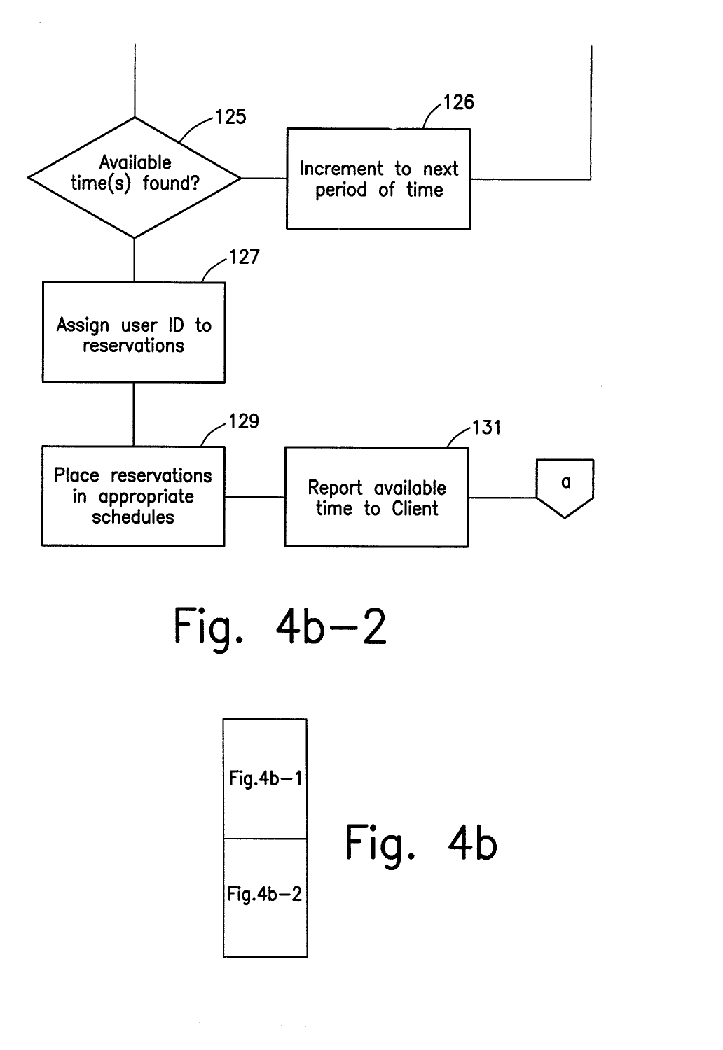

A method according to an embodiment of the present invention will be described below with respect to FIGS. 4a-b.

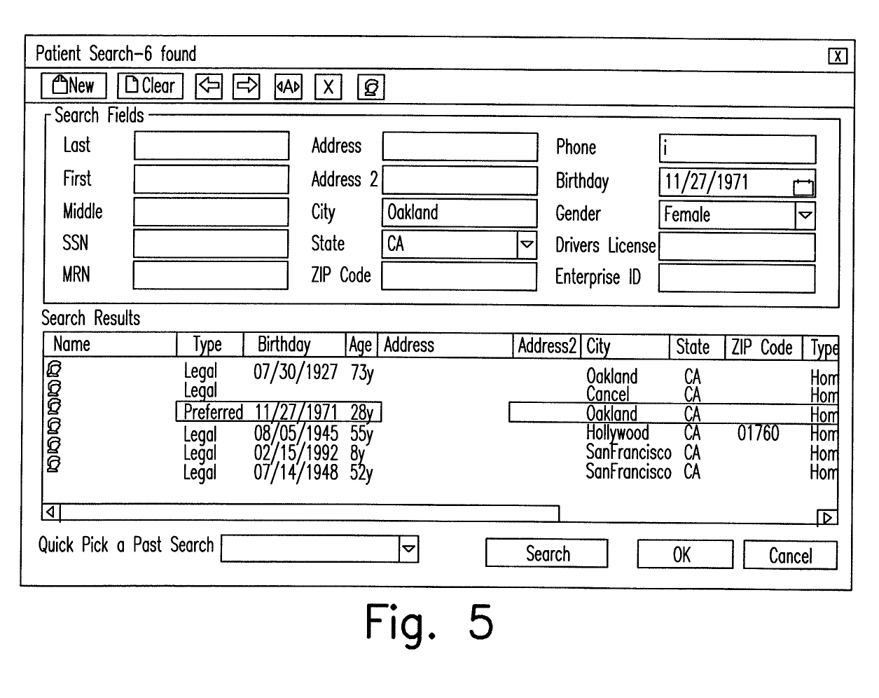

In block 101, an initialization procedure may be performed. In this example, the initialization procedure includes the loading of tasks and task requirements as further described below. In block 103, an identification request (e.g., a patient identification request) is prepared at the client. An example of a patient request is shown in FIG. 5. In this example, the patient request form includes some identification information for a particular patient (e.g., the patient's last name or portion thereof). In step 105, the server receives the patient identification request and performs a search of all patient records in the database that match the search criteria given in the identification information. In step 107, the server returns patient names that match the information provided in the patient identification request and stores the patient information in its local memory.

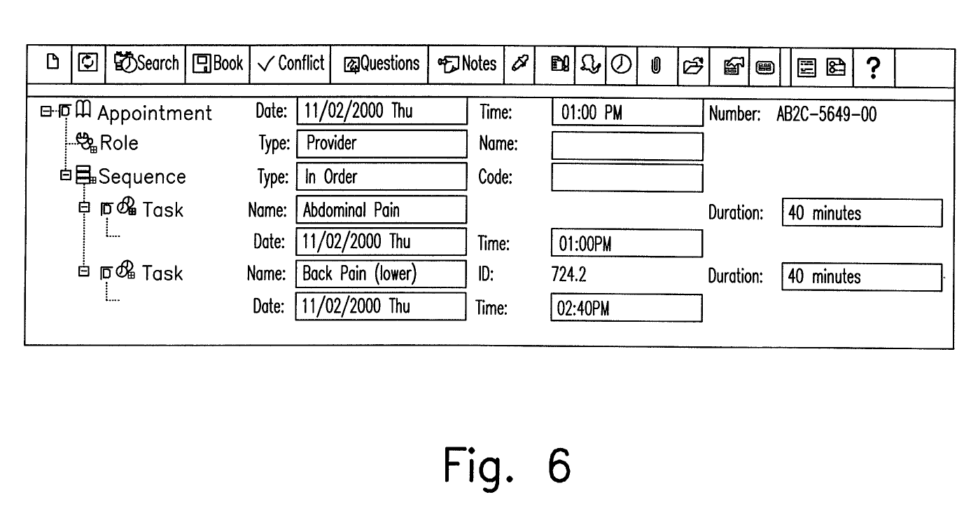

In block 109, the Client generates a task request. In this embodiment, the task request may include the following: an identification of the patient (e.g., the patient's unique social security number), a start timestamp (e.g., the earliest date/time desired for a particular appointment), and the task to be scheduled. The task to be scheduled may include any of a variety of tasks that are performed in the medical industry such as surgery, a physical examination, a treatment, etc. Optionally, the task request may also specify a resource that is to be scheduled as well. In this embodiment, resources include rooms (e.g., examination rooms, operating rooms, etc.), doctors and other staff, and equipment (an MRI machine, a dialysis machine, etc.). An example of a user interface for creating a task request is shown in FIG. 6.

In block 111, the server receives the task request and performs a lock check, which is described in further detail below. In block 113, the request may be validated to insure that it is in an appropriate form. If the request is not in a valid form, control passes to block 114 where an appropriate message is sent back to the Client for generating a new request. In block 115, any existing reservations (described below) are released since the new request would appear to be selecting a different appointment scenario.

Referring to FIG. 4b, if the task request does not include an identification of resources (decision block 117), then a task requirements list is retrieved from storage (memory) (block 118). The task requirements list provides the resources that are needed to complete a given task. For example, the task requirements lists may include the following: the minimum and maximum duration for the task; the required roles (i.e., each task typically requires a certain number of people to perform a given task); a role code (e.g., primary provider, secondary provider, primary equipment, etc.); resource type (e.g., equipment, practice group (i.e., particular group of health-care professionals)), place, service (based on the role code), etc.); required units (percentage of time that is needed (e.g., some personnel are not needed full-time during a task)); offset (start time for a particular person in a given task); and duration (amount of time needed for a particular person). One skilled in the art will appreciate that these lists of tasks may be provided in a pull-down menu to allow a user to easily fill out a complete task request form. Given this information, the user submits the identity of the patient, the required task, the required resources, and a start timestamp.

When such a properly formatted task request is received and verified, control passes to block 119 where it is determined whether the identified patient's schedule is present in the server's local memory. If it is not, then control passes to block 120 where the information is loaded into the local memory from the database. A patient's schedule is a database record that includes, in this embodiment, patient identification information and a calendar schedule indicating available and unavailable time. In this example, the patient's schedule is loaded for the current search day. In some cases, the patient's schedule will indicate that all time is available. In other cases, the patient's schedule will indicate unavailable time for previously scheduled appointments and any previously known periods of unavailability for non-medical reasons (e.g., vacation, work appointments, etc.). In block 121, it is determined whether the required resource schedules are present in the server's local memory. If not, then control passes to block 122 to load the required resource schedules to local memory from the database.

Next, in this embodiment of the present invention, it is determined whether or not there are available times for scheduling the required resources (i.e., at what points in time are all required resources available or available for the specified duration of time; block 123). As part of this procedure, the server may perform the search over a period of time (e.g., a day) beginning at the start timestamp looking for overlap in available times. If no overlap is found (block 125), then the server may perform the same search for the next period of time (e.g., the next day; block 126) until such overlap is found. When an available time is found (or multiple times), control passes to block 127, where a user ID is assigned to the reservation. In block 129, a reservation is made in the appropriate schedules for the one or more resources having available time. In other words, a temporary appointment is made in the patient's calendar and the appropriate calendars of the resources for each potential appointment reported back to the client. Control passes to block 131 where the available time(s) is/are reported to the client. Control passes to block 109 (FIG. 4a) for the user to generate a new task request or accept one of the reservations that was just reported by the server.

Returning to FIG. 4a, in block 111, a lock check is performed at the server to make sure that no one other than the intended client is claiming a created reservation. This is done by checking a user ID associated with the task request of the client with the user ID assigned to the reservation in block 127 (FIG. 4b). If the appropriate client is claiming or accepting a reservation (block 112), then the reservation(s) in the corresponding schedule(s) are changed to appointments (i.e., no longer temporary), any other reservations are cleared and the appointments are written back to the database.

A more detailed example of the method described above with respect to FIGS. 4a-b is presented below. In this example, a patient is seeking to schedule a physical examination with any doctor from a pre-defined group (e.g., the general practice doctors at a particular office) in any available rooms in the office location. Once the patient is identified, a request is sent specifying the patient, task (physical examination), and a start timestamp. Since the resources are not listed by the client, the server provides a list of resources for this task. The server then selects one or more doctors from the pre-defined group of doctors and any required room(s) desired. The server locates the patient schedule and the schedules for the selected doctors and the selected rooms (i.e., the schedules are cached in memory once accessed from the database). The server then performs the necessary processing of the schedule calendars to determine appropriate overlapping time periods (i.e., of a predetermined duration for a physical examination) between the patient's schedule, the selected doctors' schedules, and the schedules for the selected rooms. As stated above, the search may start with the date of the start timestamp and move on to the next date if no appropriate appointments are found. When an appropriate overlap is found, a reservation is made in the patient's schedule as well as the schedules for the doctor and room and the reservation is sent to the client for review. More than one reservation may be sent to the client if the bandwidth of the connection between the client and server and processing power of the client will allow it. If the client accepts the reservation, the appointment is made in the same schedules and written back to the database to reflect the updated schedules. An advantage of this example, is that the amount of processing performed at the client is significantly less than that performed at the server. Furthermore, the amount of information passing between the client and server is kept to a minimum, making it acceptable to use relatively low bandwidth connections between the two components (e.g., a PDA client communicating with the server over the Internet via a 28.8 K modem).

As a security or verification procedure, every change to the information stored in the database may be audited. Accordingly, identification information for the person operating the client machine can be recorded along with which records were modified, patient identification information, and a timestamp for when the changes were made.

As stated above, each patient and resource has a calendar associated with it. There are several types of calendars that may be provided. Examples of calendars and features include:

Open—a typical calendar indicating available and unavailable time.

Administration—a calendar that indicates the resource is working at administration tasks and not for scheduling.

Template Time—a calendar that filters available time based on the identified task type. For example, a doctor may be available on Wednesdays between 9:00 am and 5:00 pm, but may only be available for HMO procedures during this day. Thus, if the task is not an HMO procedure, such a filter would prevent the above-specified time period from being available for appointments.

Block—provides a filter on a resource such as a room or piece of equipment that allows the resource to be associated with a doctor or group of doctors earlier than others. For example, an operating room can be blocked so that it can be reserved for a task including a doctor from a particular group at any time, while other doctors would only be included if the appointment date is within a predetermined release time window from the current date.

Encumbered Time—allows a room or piece of equipment to be made unavailable for maintenance or the like.

When determining overlap between the patient's schedule and the schedules of the resources, this may be done by subtracting appointments from the calendar resulting in free time periods. The free time periods may then be filtered (e.g., as done using the Template Time or Block filters) to further limit the free time periods. The server then compares the free time periods to come up with the available appointment(s) for the patient.

The scheduling system and method may be provided with any of a variety of features. For example, reports generated by the programming code executed at the server system can be in a Hypertext Markup Language (HTML) and transmitted to the user at the client system. Also, resources are not necessarily limited to a person, place, or thing. A resource may also include a service, such as a class for individuals seeking to quit smoking. Furthermore, the tasks mentioned above can include a number of nested subtasks referred to herein as a “power set” or “superset” leading to a hierarchy with many levels. For example, a task of “open heart surgery” may be considered an order set that includes the subtasks of 1. preadmission testing; 2. surgery; 3. recovery; and 4. therapy. The subtask “therapy” may also be considered an order set and includes, in this example, its own subtasks such as 1. x-ray examination; 2. whirl pool bath; and 3. consultation with a physician. Given these tasks, the server system is adapted to allow all of these tasks to be related to each other so that each lowest order subtask can be properly scheduled with the appropriate patient and resource schedules.

Although several embodiments are specifically illustrated and described herein, it will be appreciated that modifications and variations of the present invention are covered by the above teachings and within the purview of the appended claims without departing from the spirit and intended scope of the invention.

What is claimed is:

1. A method for scheduling appointments comprising:
sending a task request from a client to a server system, said task request including patient identification and resource identification;
determining whether schedules associated with said patient identification and resource identification are stored in local memory to said server system;
loading said associated patient schedule and resource schedule from a database into said local memory;
determining available times for said resource schedule at said server system.

2. The method of claim 1 wherein said determining step begins from a start timestamp provided in said task request for a period of time.

3. The method of claim 2 wherein said determining step moves to a next period of time if not available times for said resource schedule are found.

4. The method of claim 2 wherein after said determining step, at least one available time is transmitted from the server to the client.

5. A system for scheduling appointments comprising:
a server system adapted to receive a task request from a client, said server system including local memory and said task request including patient identification and resource identification, such that schedules associated with said patient identification and resource identification are loaded into said local memory from a database so as to determine available times for said resource schedule at said server system.

6. The system of claim 5 further comprising:
a client coupled to said server system via a transmission medium.

7. The system of claim 6 further comprising:
a database coupled to said server system.
